(19) United States
(12) Patent Application Publication
(10) Pub. No.: US 2007/0051600 A1
(43) Pub. Date: Mar. 8, 2007

(54) Slide switch

(75) Inventor: Liang Sun, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/516,340

(22) Filed: Sep. 6, 2006

(30) Foreign Application Priority Data
Sep. 6, 2005 (CN) 200520075307.4

(51) Int. Cl. H01H 1/36

(52) U.S. Cl. 200/252

(57) ABSTRACT

A slide switch (1) comprises an insulative housing (5), a fixed contact unit (6) embedded in an inner side face of the housing (5) and a moveable contact (7) disposed in the housing against the fixed contact unit (6), an actuator (8) for actuating the moveable contact (7) to slide relative to the fixed contact unit (6) and a cover (8) mounted on the housing (5), wherein the actuator (8) defines side ribs and the housing (5) defines a leading member corresponding to the side ribs. In assembly, the leading member of the housing (5) engages with the side ribs of the actuator (8).

### BACKGROUND OF THE INVENTION

1. Field of the Invention

The present invention relates to a miniature slide switch, and particularly to a slide switch used in consumer electronic applications.

2. Description of the Prior Art

The personal electronic consumer products such as cell phones are designed to comply with a miniaturization trend as customers require. Correspondingly, electronic elements such as switches employed in those products are required to be miniature.

A conventional slide switch 1′ disclosed in FIG. 5 comprises a insulative housing 5′, a fixed contact unit 6′ mounted in the housing 5′, a moveable contact 7′ received in the housing 5′ for establishing electrical connection with the fixed contact unit 6′, an actuator 8′ disposed with a slider 81′ for actuating the moveable contact 7′ to slide in the housing 5′, a cover 9′ covered on the housing 5′. The slide switch 1′ attains electrical connection with a printed circuit board by leads of the fix contact unit 6′ connecting with the printed circuit board. In addition, the control of the circuit can be realized by the actuator 8′ controlling contact or break between the moveable contact 7′ and the fixed contacts unit 6′. However the actuator 8′ may come out of predetermined position, being short of lead members in the sliding direction, during sliding the actuator in the housing, which can lead to electrical connection failure of the inner switch because of the slant actuator colliding with inner parts of the slide switch. So the stability and validity of the electrical control of the switch can be affected.

Hence, an improved slide switch is required to overcome the disadvantages of the prior art.

### BRIEF SUMMARY OF THE INVENTION

An object of the present invention is to provide a slide switch which can lead an actuator in sliding direction and secure the actuator in a desired position.

A slide switch in accordance with a preferred embodiment of the present invention comprises an insulative housing, a fixed contact unit embedded in a inner side face of the back of the housing and a moveable contact disposed against the fixed contact unit, an actuator for actuating the moveable contact to slide relative to the fixed contacts and a cover mounted on the housing, wherein the actuator defines side ribs and the housing defines a leading member for engaging with the side ribs of the actuator.

Relative to the present technology, the slide switch in accordance with the invention can guide the actuator in a predetermined sliding direction by the leading member. The leading member is disposed in the housing and secures the actuator in a direction vertical to the sliding direction, which prevents part of the slide switch from invalid contact due to the actuator slant in the predetermined direction, and hence enhances the reliability and stability of the slide switch.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded, perspective view of a slide switch of a first embodiment according to the present invention;

FIG. 2 is a partially assembled view of the slide switch of FIG. 1, wherein an actuator is assembled in a housing;

FIG. 3 is an exploded, perspective view of the slide switch in FIG. 1,

FIG. 4 is an exploded, perspective view of a slide switch of a second embodiment according to the present invention;

FIG. 5 is an exploded, perspective view of a slide switch according to a conventional invention.

### DETAILED DESCRIPTION OF THE PREFERRED EMBODIMENTS

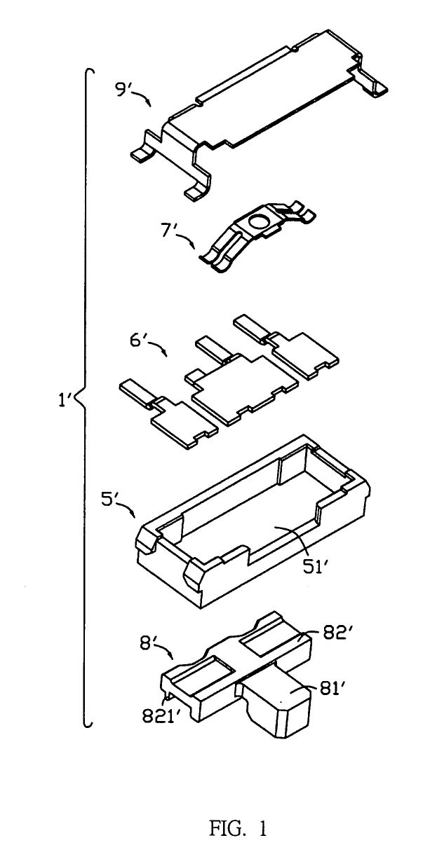

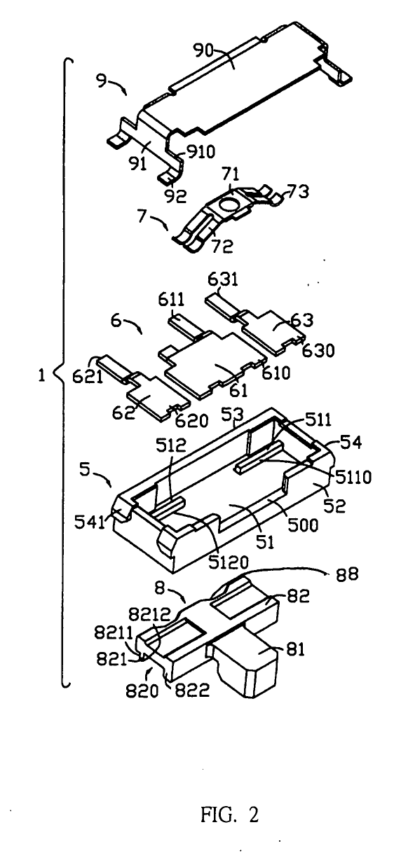

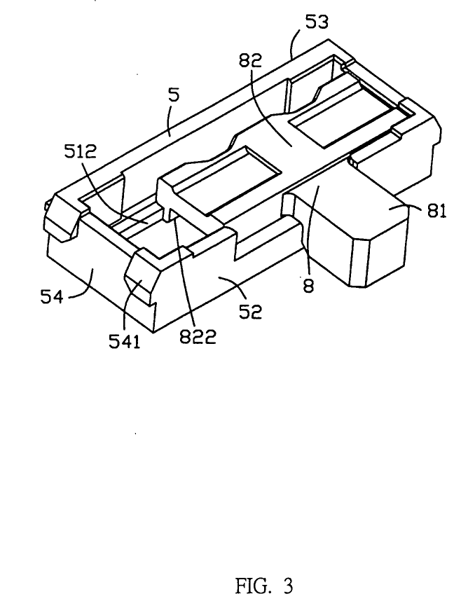

Referring to FIGS. 1, 2 and 3, a slide switch 1 in accordance with a first preferred embodiment of the present invention comprises an insulative housing 5, a fixed contact unit 6 embedded in an inner side face of the back of the housing 5, a moveable contact 7 disposed in the housing 5 against the fixed contact unit 6, an actuator 8 for actuating the moveable contact 7 to slide relative to the fixed contact unit 6 in the housing 5, and a cover 9 mounted on the housing 5.

The moveable contact 7 is made of metal material and comprises a center portion 71, a pair of connection portions (72, 73) extending from the center portion 71 and a pair of contacting portions (74, 75) extending from the connection portions (72, 73) respectively. The contacting portions (74, 75) curves upwardly for connecting with the fixed contact unit 6.

The actuator 8 comprise an operation lever or knob 81 and a slider 82, wherein the slider 82 defines a concave 820 for receiving the center portion 71 of the moveable contact 7. A pair of side ribs disposed on opposite sides of the concave 820 comprises a first side rib 821 and a second side rib 822. The first side rib 821 and the second side rib 822 extend though the actuator 82 in a transverse direction, wherein the first side rib 821 defines a first side 8211 and a second side 8212. A pair of recesses 88 are on one side of the slider 82 opposite to the operation lever 81 and cooperating with corresponding protrusions (not shown) on the cover 90 to retain the actuator 8 at “ON” or “OFF” positions, respectively.

The insulative housing 5 is substantially a rectangular case and is formed with a bottom surface 51 and four sidewalls extending from the bottom surface 51 vertically, namely a first sidewall 52, a second sidewall 53 opposite the first sidewall 52, a third sidewall and a fourth sidewall 54 connecting the first sidewall 52 and the second sidewall 53. The four sidewalls form cooperatively a cavity 50 for receiving the actuator 8. The first sidewall 52 defines an opening 500 for receiving the actuator 8. Plural projects 541 extend from the third sidewall and the fourth sidewall 54 adjacent to the junctions of the first sidewall 52 and the second sidewall 53. In this embodiment of the invention, the leading member is disposed as a holding rib corresponding to the first side rib 821 in the bottom surface 51 of the housing 5. The holding rib defines a contact surface corresponding to the first side 8211. Relating to this embodiment, the holding rib disposed as two separated parts comprises a first holding rib 511 and a second holding rib 512. The first holding rib 511 and the second holding rib 512 are disposed apart from each other on two ends of the bottom surface 51 in the sliding direction of the actuator 8, wherein the contact surface disposed on the first holding rib 511 is a first contact surface 5110 and the contact disposed on the second holding rib 512 is a second contact surface 5120.

The fixed contact unit 6 is embedded in the housing 5 and exposes partially to the cavity 50 of the housing 5. The fixed contact unit 6 comprises a first contact 61 disposed on the center of the housing, and a second 62 and a third contact 63 disposed on the two opposite sides of the first contact 61. The first contact 61 defines a head portion 610 and a tail portion 611, wherein the head portion 610 is located at a center of the bottom surface 51 of the housing 5 and the tail 611 penetrates through the housing 5 from the bottom surface thereof. The second contact 62 and the third contact 63 define a second head portion 620 and a third head portion 630 respectively arranged at two opposite sides of the bottom surface 51 of the housing 5 and a second tail 621 and a third tail 631 penetrating through the housing 5 from the bottom surface 51 thereof.

The cover 9 comprises a base portion 90 engaging with the housing 5, a securing portion 91 extending and bent backwardly from two opposite ends of the housing 5, and a plurality of hooks 92 extending downwardly and vertically from a front-end of the securing portion 93. The securing portion 93 defines a mating rib 910 corresponding to the protrusion 541 of the housing 5.

Referring to FIGS. 1, 2 and 3, in assembling, the moveable contact 7 and the actuator 8 are initial mounted to the cavity 50 of the housing 5 embedded with the fixed contact unit 6, and then the cover 9 is disposed on the housing 5. At this time, the protrusion 541 of the housing 5 abuts against the mating rib 910; the contact portion (74, 75) of the moveable contact 7 abuts against the first head 610 of the first contact 61 and the second head 620 of the second contact 62 or the first head 610 of the first contact 61 and the third head 620 of the third contact 630 selectively. The side rib 821 of the actuator 8 engages with the first holding rib 511 and the second holding rib 512. Hence, the actuator 8 sliding in the housing can be led by the first side rib 821 in the sliding direction and secured by the first side rib 821 in the direction vertical to the sliding direction, which can limit the travel of the actuator 8 and maintain the stability of electrical control of the slide switch 1.

In using, the engagement of the first side rib 821 of the actuator with the holding rib 511 and the second holding rib 521 of the housing 5 can make the sliding member of the actuator 8 relative to the housing 5 stable and reliable, thereby preventing contacting failure due to the deviation of the actuator 8 and ensuring the stability of the control of the slide switch 1.

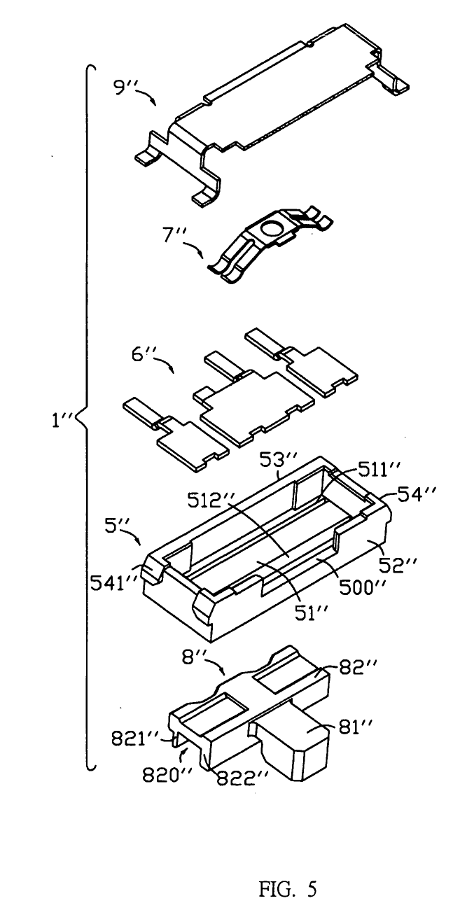

Referring to FIG. 5, a slide switch 1″ in accordance with a second preferred embodiment of the present invention comprises an insulative housing 5″, a fixed contact unit 6″ embedded in an inner side face of the back of the housing 5″, a moveable contact 7″ disposed in the housing against the fixed contact unit 6″, an actuator 8″ for actuating the moveable contact 8″ to slide relative to the fixed contact unit 6″ in the housing 5″, and a cover 9″ mounted on the housing 5″.

The actuator 8″ comprises a lever 81″ and a slider 82″, wherein the slider 82″ defines a concavity 820″ for receiving the center portion 71″ of the moveable contact 7″. A pair of side ribs is disposed on opposite sides of the concave 7″ and form a first side rib 821″ and a second side rib 822″. The first side rib 821″ and the second rib 822″ extend through the actuator 8″ in a transverse direction respectively.

The insulative housing 5″ is substantially a rectangular case and is formed with a bottom surface 51″ and four sidewalls extending from the bottom surface 51″ vertically namely a first sidewall 52″, a second sidewall 53″ opposite to the first sidewall 52″, a third sidewall and a fourth sidewall 54″ interconnecting the first sidewall 52″ and the second sidewall 53″. The four sidewalls form cooperatively a cavity 50″ for containing the actuator 8″ partially. The first sidewall 52″ defines an opening 510″ for receiving the lever 81″ of the actuator 8″. Plural projections 541″ extend from the third sidewall and the fourth sidewall 54″ adjacent to junctions of the first sidewall 52″ and the second sidewall 53″. In this embodiment of the invention, the leading member is disposed as a first recess 511″ and a second recess 512″ corresponding to the first side rib 821″ and the second side rib 822″ in the bottom surface 51″ of the housing 5″.

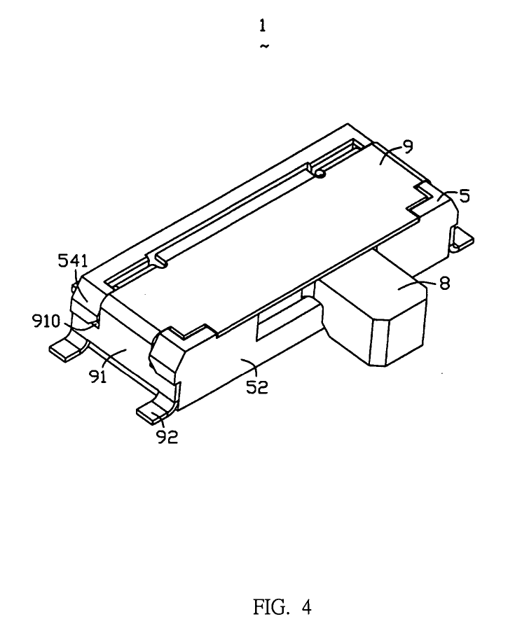

Referring to FIG. 4, in assembling, the moveable contact 7″ and actuator 8″ is initially mounted to the cavity 51″ of the housing 5″ embedded with the fixed contact unit 6″ by insert molding and then the cover 9″ is disposed on the housing 5″. At this time, the protrusion 541″ of the housing 5″ abuts against the mating wall 910″; the contact portions 74″, 75″ of the moveable contact 7″ abut against the first head 610″ of the first contact 61″ and the second head 620″ of the second contact 62″ or the first head 610″ of the first contact 61″ and the third head 630″ of the third contact 63″ selectively. The first side rib 821″ and the second side rib 822″ of the actuator 8″ engage with the first recess 511″ and the second recess 512″ respectively. Hence the actuator 8″ can be led by the first recess 511″ and the second recess 512″ in the sliding direction and supported by the first recess 511″ and the second recess 512″ in the direction vertical to the sliding direction, which can limit the track of the actuator 8″ and maintain the stability of electrical control of the slide switch 1″.

In operation, the engagement of the first side rib 821″ and the second side rib 822″ of the actuator 8″ with the first recess 511″ and the second recess 512″ of the housing 5″ respectively can make actuator 8″ slide relative to the housing 5″ stably and reliably which prevent contacting failure due to the deviation of the actuator 8″ and assure the stability of the electrical control of the slide switch 1″.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A slide switch comprising:
an insulative housing;
a fixed contact unit embedded in the housing;
a moveable contact disposed in the housing against the fixed contact unit;
an actuator for actuating the moveable contact to slide relative to the fixed contact in the housing;
wherein the housing defines a leading member leading the actuator to slide relative to the housing.

2. The slide switch as claimed in claim 1, wherein the actuator defines a first side rib and said leading member is a holding rib, which abuts against the side rib.

3. The slide switch as claimed in claim 2, wherein the holding rib is disposed as two separated parts.

4. The slide switch as claimed in claim 1, wherein the actuator defines a first side rib and a second side rib, and said leading member comprises a first recess and a second recess for receiving the first side rib and the second side rib respectively.

5. The slide switch as claimed in claim 4, wherein the height of the first holding rib and the second holding rib fittingly matches the height of the side rib.

6. A slide switch comprising:
an insulative housing defining a cavity;
a fixed contact unit disposed in the housing; and
a moveable contact unit associated with an actuator which is moveable linearly in the housing; wherein
the housing defines a first linear structure and the actuator defines a second linear structure engaged with the first linear structure for assuring linear movement of the actuator relative to the housing.

7. The slide switch as claimed in claim 6, wherein said first linear structure and said second linear structure are located around a retention structure of the actuator which determines the actuator is located at ON or OFF position.

8. The slide switch as claimed in claim 6, wherein said first linear structure and said second linear structure are located on one side of the actuator while an operation knob is located on another side oppositely.
